(19) United States
(12) Patent Application Publication
(10) Pub. No.: US 2013/0254276 A1
(43) Pub. Date: Sep. 26, 2013

(54) ONLINE SOCIAL MEDIA PLATFORM THAT RECORDS AND AGGREGATES MOOD IN COLOR

(71) Applicant: Gabriel-Angelo Ajayi, Salem, MA (US)

(72) Inventor: Gabriel-Angelo Ajayi, Salem, MA (US)

(21) Appl. No.: 13/425,361

(22) Filed: Mar. 20, 2012

(51) Int. Cl. G06F 15/16

(52) U.S. Cl. 709/204

(57) ABSTRACT

A system, method, and computer program for mood mapping with color within a social network is provided. Data about the mood and subsequent data of a plurality of social network members is received. A member of the plurality of social network members is permitted to establish a relationship with any other member of the plurality of social network members with whom a relationship is desired. Mood data and subsequent data are then shared between social network members with a relationship. A member's status is updated with their current mood represented in color as represented: GREEN (happy), ORANGE (excited), PINK (tender), YELLOW (scared), RED (angry), BLUE (sad), GREY (transition). Mood data represented in color from the plurality of social network members is aggregated and displayed in real-time on a world map and summarized via a device containing circles that proportionally displays aggregated color mood data.

### BACKGROUND OF THE INVENTION

The present invention relates to social media methods and platforms and more particularly, to an online social media platform that records and aggregates mood in color.

Much of the existing social media platforms allow members to share detailed information about themselves and their activities. However, no current social media platform provides a central feature where sharing of mood is the central focus. While some systems may include a generic mood indicator, there are no ways to determine the overall mood for a given population.

As can be seen, there is a need for an improved social media platform that records and aggregates user's moods in color.

### SUMMARY OF THE INVENTION

In one aspect of the present invention, a computer-implemented method, written as a programmable code, stored on a computer readable medium, and adapted to provide a mood tracking social media platform, the method comprises allowing a user to join into the social media platform; obtaining a mood of the user by having the user select from one of a plurality of pre-selected moods, each of the plurality of pre-selected moods being assigned a color; and sharing the mood of the user with other users of the social media platform.

In another aspect of the present invention, a software application, written in one or more computer codes, stored on a computer readable medium, the software application adapted to provide a mood tracking social media platform, the software application comprising program code adapted to allow a user to join into the social media platform; obtain a mood of the user by having the user select from one of a plurality of pre-selected moods, each of the plurality of pre-selected moods being assigned a color; and share the mood of the user with other users of the social media platform.

These and other features, aspects and advantages of the present invention will become better understood with reference to the following drawings, description and claims.

### BRIEF DESCRIPTION OF THE DRAWINGS

FIG. 1 is a view of a world map showing aggregated moods of users of a social media platform according to an exemplary embodiment of the present invention; and

FIG. 2 is a flow chart describing certain features for the use of the social media platform of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a social media platform that allows users to publish their mood from a dedicated platform that visibly shows individual and aggregated mood in color. Other social media platforms do not make it possible for members to clearly publish and highlight their mood and to visibly see the aggregated mood of a given population. With the platform of the present invention, members can focus specifically on their moods, visibly publish their moods to their network and see aggregated moods of any given population in color.

The platform of the present invention may be written and provided as a software product. The software may be written in any one or more programming languages. In some embodiments, the software may be designed to operate on a computer system, having a central processing unit, memory and other typical computer components. In some embodiments, the software may reside on a server and operate on various computers or computer terminals. In some embodiments, the software may reside at least partially on a server or cloud-based system or on an internet-based system. In some embodiments, the software may be designed for a portable electronic device, such as a tablet computer, smartphone, or the like.

In some embodiments, the platform may be a stand-alone system, providing the user with a social media network with the capability of publishing their moods and aggregating moods of all of the users. In other embodiments, the platform may be integrated into an existing social media network, providing users of that social media network the capability of publishing their moods and aggregating moods of all of the users of that network. In still other embodiments, the platform may be integrated into multiple social media networks, providing users of each of the social media networks the capability of publishing their moods and either aggregating moods of all of the users of the platform of the present invention, or aggregating moods of users of each of the social media networks into which the platform is integrated. The software of the present invention may include computer code, disposed on a computer readable medium, adapted to perform the various functions as described herewithin.

Referring to the Figures, the platform may be delivered to the user in a web-based, internet-accessed interface. The website may allow a user to publish their mood. This mood may be colored based on pre-configured color categories. For example, green may indicate happy, orange may indicate excited, pink may indicate tender, yellow may indicate scared, red may indicate angry and blue may indicate sad. Of course, the colors may be assigned different moods and additional or fewer mood/color options may be available to the user, depending on the application of the platform.

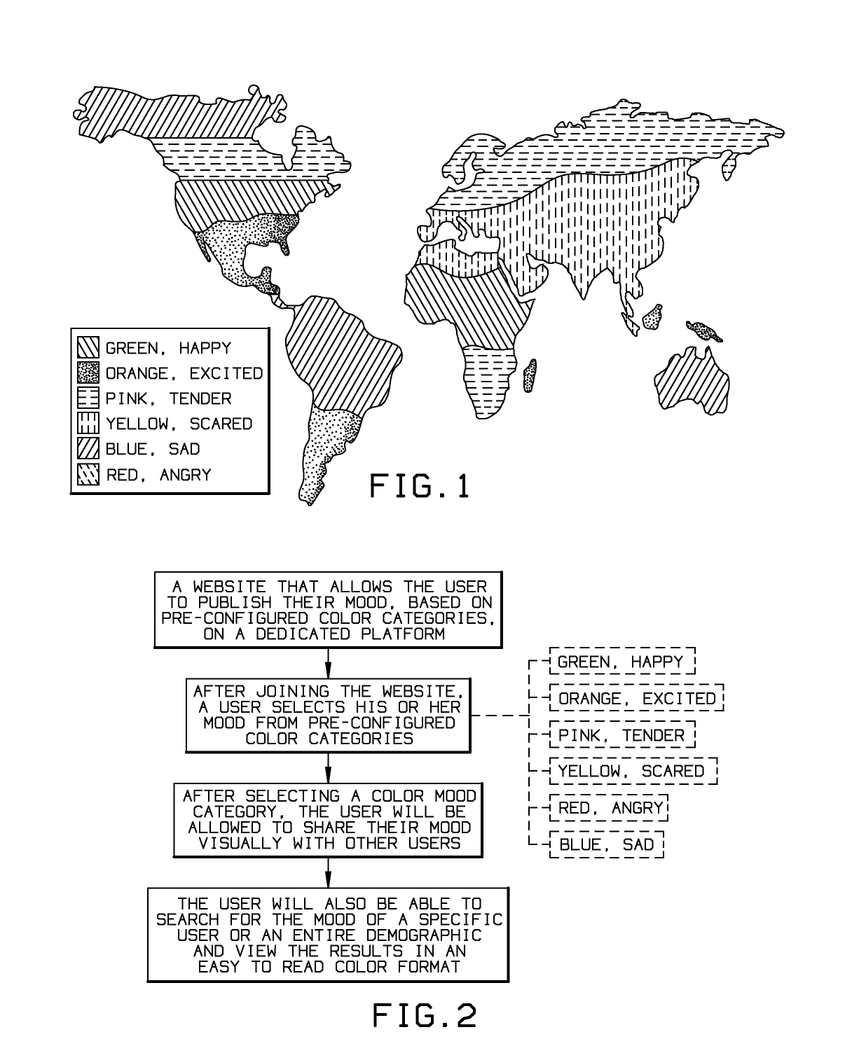

After selecting a color mood category, the user can share their mood visually with other users. The user can also search for the mood of a specific user or an entire demographic and view the results in an easy to read color format. For example, a world map, as shown in FIG. 1, may be color coded to display prevalent moods through certain regions. A user may have the option to zoom into certain areas on the map. For example, a user may zoom on the state of Pennsylvania to see the overall mood throughout the state, or the user may zoom on Philadelphia to see the overall mood throughout the city. In some embodiments, the social media platform may provide a color wheel chart to signify the mood of a selected population.

The platform of the present invention may allow users to “friend” other users and see their profile and, thus, their mood. Mood indicators may appear on a user's profile as a background color, a color around their photo, or simply a textual and/or color bar displayed somewhere on that user's page.

The platform of the present invention may generate mood data based on the user's input. Such data may be useful in polling the public mood, especially after a certain event. For example, if a presidential candidate tours a state and that state's aggregate mood changes from green (happy) to blue (sad), this may be useful information for the candidate. The platform of the present invention may also be useful in generating mood readouts on certain demographics. For example, a user may be able to determine that people aged 16-19 are red (angry) in a certain area, while people aged 65+ are orange (excited), or the like.

It should be understood, of course, that the foregoing relates to exemplary embodiments of the invention and that modifications may be made without departing from the spirit and scope of the invention as set forth in the following claims.

What is claimed is:

1. A computer-implemented method, written as a programmable code, stored on a computer readable medium, and adapted to provide a mood tracking social media platform, the method comprising:
allowing a user to join into the social media platform;
obtaining a mood of the user by having the user select from one of a plurality of pre-selected moods, each of the plurality of pre-selected moods being assigned a color; and
sharing the mood of the user with other users of the social media platform.

2. The method of claim 1, further comprising generating a mood map showing the mood of users of the social media platform for a particular geographical region.

3. The method of claim 2, where the geographical region is the world.

4. The method of claim 1, wherein the social media platform is integrated with a social media network.

5. The method of claim 1, wherein the social media platform is added into an existing social media network.

6. The method of claim 1, further comprising searching for a user of the social media platform.

7. The method of claim 1, further comprising providing a color wheel chart to show the mood of a selected population.

8. A software application, written in one or more computer codes, stored on a computer readable medium, the software application adapted to provide a mood tracking social media platform, the software application comprising program code adapted to:
allow a user to join into the social media platform;
obtain a mood of the user by having the user select from one of a plurality of pre-selected moods, each of the plurality of pre-selected moods being assigned a color; and
share the mood of the user with other users of the social media platform.

9. The software application of claim 8, where the software application has program code adapted to search for a user within the social media platform.

10. The software application of claim 8, further comprising program code adapted to generate a mood map showing the mood of users of the social media platform for a particular geographical region.
